(19) United States
(12) Patent Application Publication
(10) Pub. No.: US 2008/0104112 A1
(43) Pub. Date: May 1, 2008

(54) Method and Apparatus for Music Play List Control

(75) Inventors: Richard Vincent Nicholl, Raleigh, NC (US); Charles L. Copello, Raleigh, NC (US)

Correspondence Address: COATS & BENNETT/SONY ERICSSON, 1400 CRESCENT GREEN, SUITE 300, CARY, NC, 27511, US

(73) Assignee: Sony Ericsson Mobile Communications AB, Lund (SE)

(21) Appl. No.: 11/553,800

(22) Filed: Oct. 27, 2006

(51) Int. Cl. G06F 17/00

(52) U.S. Cl. 707/104.1

(57) ABSTRACT

The mobile device described herein dynamically generates a new play list of songs having an attribute of a currently playing song. More particularly, the mobile device receives a change play list command that identifies a default attribute. Exemplary attributes include artist, album, composer, and genre of the current song. In response, the mobile device automatically generates the new play list that includes all songs having the default attribute of the current song. For example, the mobile device may generate a new play list of songs having the same artist as the current song. Subsequently, the mobile device plays the audio files in the new play list.

### BACKGROUND

The present invention relates generally to mobile devices, and more particularly to portable media players.

Portable media players enable users to use a single mobile device to download, store, and play music from a wide range of artists and genres. Media players may be stand alone devices or may be incorporated into other portable electronic devices, such as cellular telephones. To listen to songs, the user selects a play option that systematically plays songs from a stored music library in a user specified order, such as sequentially, randomly, etc.

The user may set up personal play lists to organize the songs stored in the music library. Conventionally, generating a personal play list requires executing a series of steps that link a desired collection of songs with a play list. The user may then select the play list to listen to the songs in the play list. Conventional devices do not provide an easy method for selecting and playing songs having the same artist, composer, album, genre, etc., as a currently playing song. Even if an existing play list includes all of the desired songs, i.e., songs from the same artist as the current song, the user must navigate a system of menus to access and select the play list. When a play list does not already exist, the user can only access the desired songs, i.e., songs from the same artist as the current song, by navigating a system of menus and individually selecting and playing each song. In either case, menu navigation is not always convenient. Therefore, there remains a need for an improved user interface for play list control.

### SUMMARY

A method and apparatus according to the present invention plays audio files from a pre-defined play list on a media player of a mobile device. Responsive to receiving a change play list command during a currently playing audio file, a processor in the mobile device dynamically generates or retrieves a new play list of audio files based on the current audio file. Subsequently, the media player plays the audio files in the new play list. In one embodiment, the processor generates the new play list of audio files based on one or more attributes of the current audio file. Exemplary attributes include artist, album, composer, and genre of the current audio file.

### BRIEF DESCRIPTION OF THE DRAWINGS

FIG. 1 shows a block diagram of an exemplary mobile device according to the present invention.

FIG. 2 shows an exemplary music library stored in the memory of the mobile device shown in FIG. 1.

FIG. 3 shows a flow chart for an exemplary process according to the present invention.

FIG. 4 shows a flow chart for another exemplary process according to the present invention.

FIG. 5 shows a flow chart for another exemplary process according to the present invention.

### DETAILED DESCRIPTION

While listening to a current song on a mobile device, a user may want to hear more songs from the corresponding artist, album, composer, genre, etc. Using a conventional mobile device, the user must first navigate a menu system to select and play the desired song(s) or play list. However, navigating a menu system is sometimes difficult or impossible, such as when the user is driving a car or riding a bicycle.

The present invention addresses this problem with a mobile device that dynamically generates a new play list based on a song currently playing on the mobile device. More particularly, the mobile device automatically generates or retrieves the new play list based on an attribute of the current song when the mobile device receives a change play list command. For example, when the mobile device receives a change play list command, the mobile device automatically generates or retrieves a new play list that includes all songs from the same album as the current song. The mobile device then plays songs from the new play list.

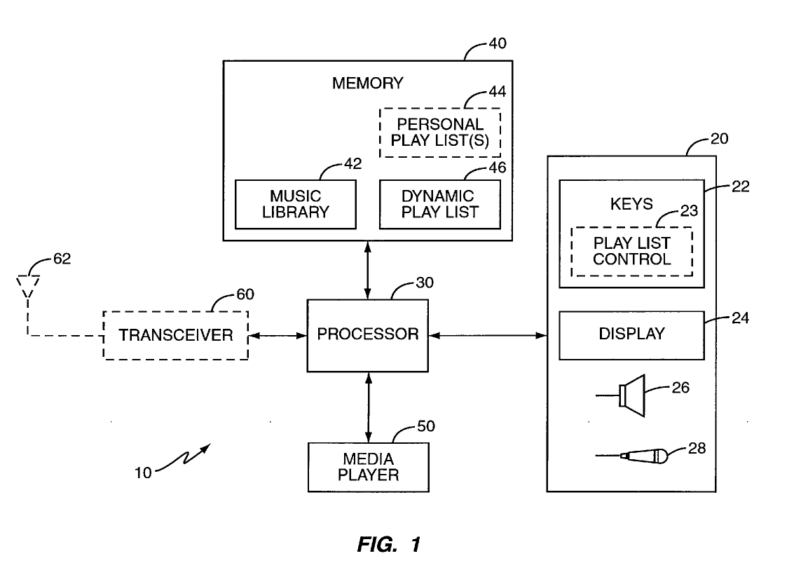

FIG. 1 shows one exemplary mobile device 10 applicable to the present invention. Mobile device 10 may comprise any known portable electronic device capable of playing audio files. Exemplary mobile devices 10 include but are not limited to digital music players and wireless communication devices, such as cellular telephones, personal data assistants, palm top computers, etc.

Mobile device 10 includes a user interface 20, processor 30, memory 40, and media player 50. When mobile device 10 is a wireless communication device, mobile device 10 may also include a transceiver 60 and antenna 62. Transceiver 60 may operate according to any known standard. Exemplary communication standards include but are not limited to, Code Division Multiple Access (CDMA), Global System for Mobile Communications (GSM), Universal Mobile Telecommunications System (UMTS), Orthogonal Frequency Division Multiplexing (OFDM), etc.

User interface 20 enables the user to interact with the mobile device 10. The user interface 20 may include, for example, one or more input keys 22, a display 24, a speaker 26 or other audio output device, and a microphone 28 or other audio input device. Processor 30 performs various processing tasks according to programs stored in memory 40. Memory 40 stores data and programs needed for mobile device operation. Memory 40 further stores a music library 42 containing a plurality of audio files. In some embodiments memory 40 may also store one or more pre-defined personal play lists 44 that group a subset of the audio files in the music library 42 according to user preference. Media player 50 processes the stored audio files and sends audio signals to speaker 26 to output audible sound to the user. While the following refers to the stored audio files as songs, it will be appreciated that the present invention also applies to other non-musical audio files stored in music library 42.

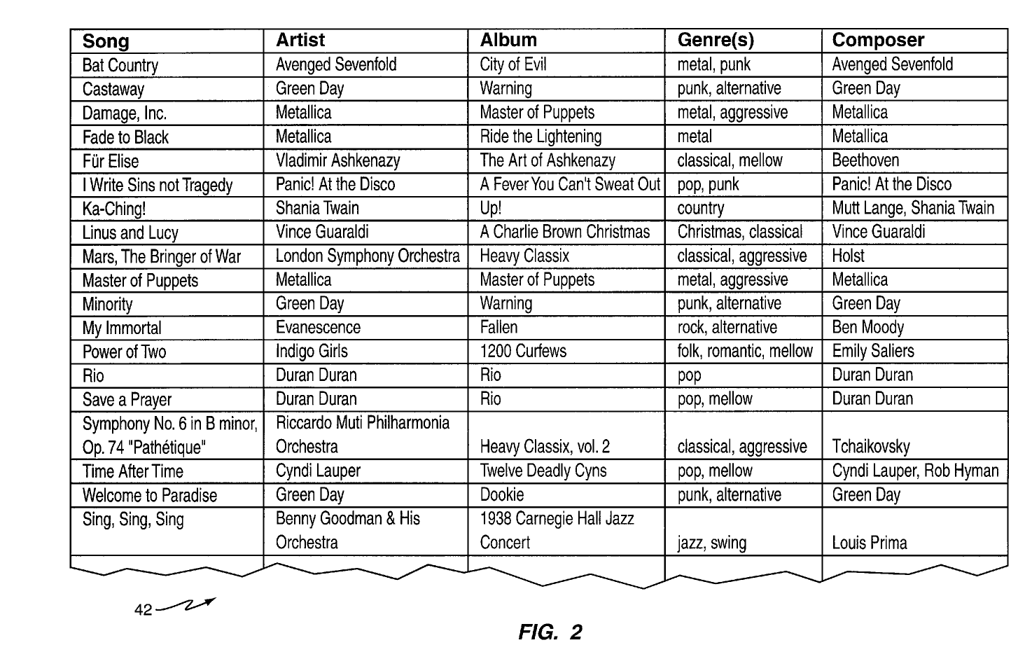

FIG. 2 shows a portion of an exemplary music library 42. Each song has one or more attributes. As used herein, an attribute comprises a characteristic or property of a song. Exemplary attributes include but are not limited to artist, album, composer, and genre, such as metal, hard rock, hip hop, punk, alternative, pop, classical, country, folk, jazz, swing, seasonal, aggressive, mellow, romantic, decade-specific, etc.

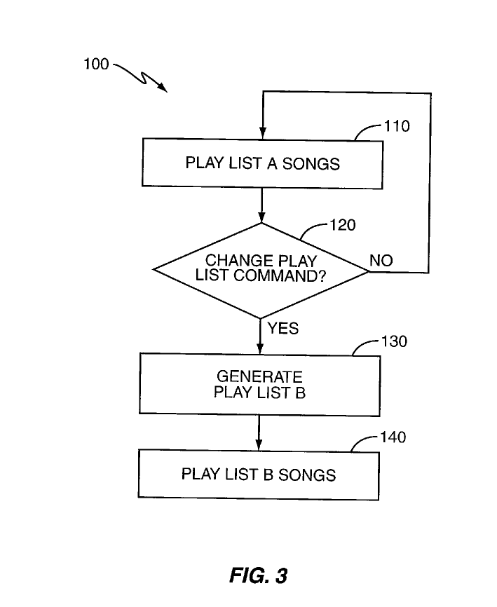

FIG. 3 shows an exemplary process 100 associated with the present invention. In operation, media player 50 plays the songs stored in music library 42 in any desired order, e.g., sequentially, randomly, etc., (block 110). Responsive to receiving a change play list command during playback of a current song (block 120), processor 30 dynamically generates a new play list 46 based on an attribute of the current song (block 130). According to one embodiment, processor 30 generates the new play list 46 by first comparing the attribute of the current song to the attributes of all songs stored in the music library 42. Processor 30 then includes all songs having the attribute of the current song in the new play list 46, and temporarily stores the new play list 46 in memory 40. For example, processor 30 may generate the new play list 46 by identifying all songs in the music library 42 having the same artist as the current song. Subsequently, media player 50 plays songs from the new play list 46 (block 140). It will be appreciated that media player 50 may wait until the completion of the current song before playing songs from the new play list 46. Alternatively, media player 50 may halt playback of the current song to immediately begin playing songs from the new play list 46.

Mobile device 10 may receive the change play list command from any number of user input devices. In one exemplary embodiment, the user input device comprises an input key 22, such as play list control button 23, that generates the change play list command responsive to user activation. Control button 23 may comprise a dedicated play list control button or may comprise a multi-function control button that operates as a dedicated control button during music playback operations. Processor 30 associates a pre-determined default attribute with control button 23. The manufacturer may preset the default attribute associated with button 23 or the user may selectively set the default attribute associated with button 23. For example, the user may selectively set “composer” as the default attribute associated with button 23. In operation, processor 30 therefore dynamically generates a new play list 46 based on the composer responsive to activation of control button 23.

In another exemplary embodiment, the user input device comprises a microphone 28 that detects an audible change play list command. Processor 30 may associate a pre-determined manufacturer or user-selected attribute with the audio command. Alternatively, the audio command may explicitly identify the attribute. For example, when the user says “play artist,” processor 30 may generate a new play list 46 comprising songs performed by the same artist as the current song. Alternatively, when the user says “play album,” “play genre,” or “play composer,” processor 30 may generate a new play list 46 comprising songs from the same album, genre, or composer, respectively, as the current song. It will be appreciated that the audio command embodiment of the present invention also enables the user to further specify a desired genre. For example, if the user says “play genre” during playback of “Minority,” processor 30 may generate a new play list 46 comprising songs having a “punk” genre and an “alternative” genre. However, if the user says “play genre alternative” during playback of “Minority,” the processor 30 may generate a new play list 46 comprising only songs having an “alterative” genre.

It will be appreciated that a second change play list command, i.e., a second activation of button 23 or an audio “revert” command, may cause media player 50 to revert back to playing songs from the music library 42. More particularly, responsive to the second change play list command, processor 30 directs media player 50 to stop playing songs from new play list 46 and to instead play songs from the music library 42. Processor 30 may either delete the previously generated attribute-specific play list 46 from memory 40 or may permanently store the attribute-specific play list 46 as a personal play list in memory 40.

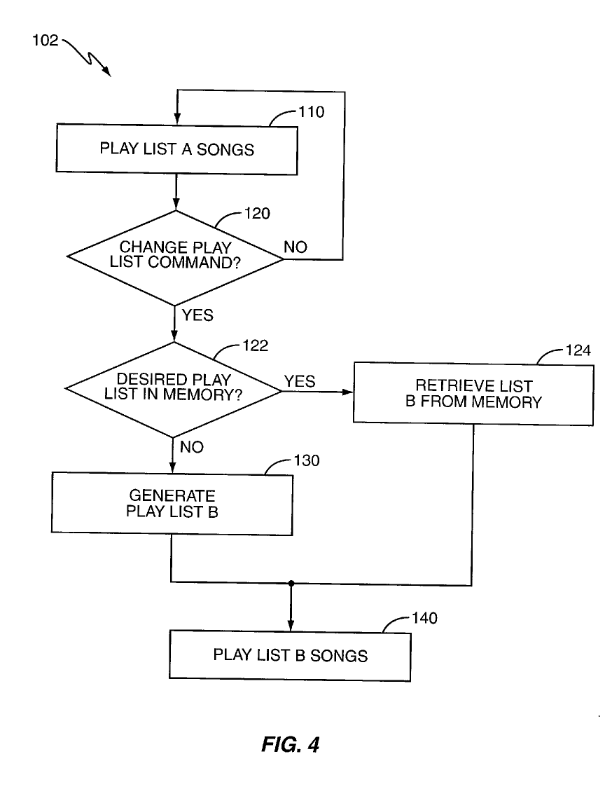

It will be appreciated that when an attribute-specific play list 46 is stored in memory 40 as a personal play list, the present invention may be adapted to automatically retrieve this previously generated play list from memory 40 responsive to the changing play list command. FIG. 4 shows an exemplary process 102 according to this embodiment. Media player 50 plays the songs stored in music library 42 in any desired order, e.g., sequentially, randomly, etc., (block 110). Responsive to receiving the change play list command during playback of a current song (block 120), processor 30 searches memory 40 for a play list 46 of songs having the default attribute of the current song (block 122). For example, processor 30 may search memory 40 for a play list 46 of songs by the artist of the current song. If the play list 46 already exists in memory 40 (block 122), processor 30 retrieves the play list 46 (block 124). If the play list 46 does not already exist (block 122), processor 30 dynamically generates a new play list 46 based on the default attribute (block 130). In either case, media player 50 plays the songs from the attribute-specific play list 46 (block 140).

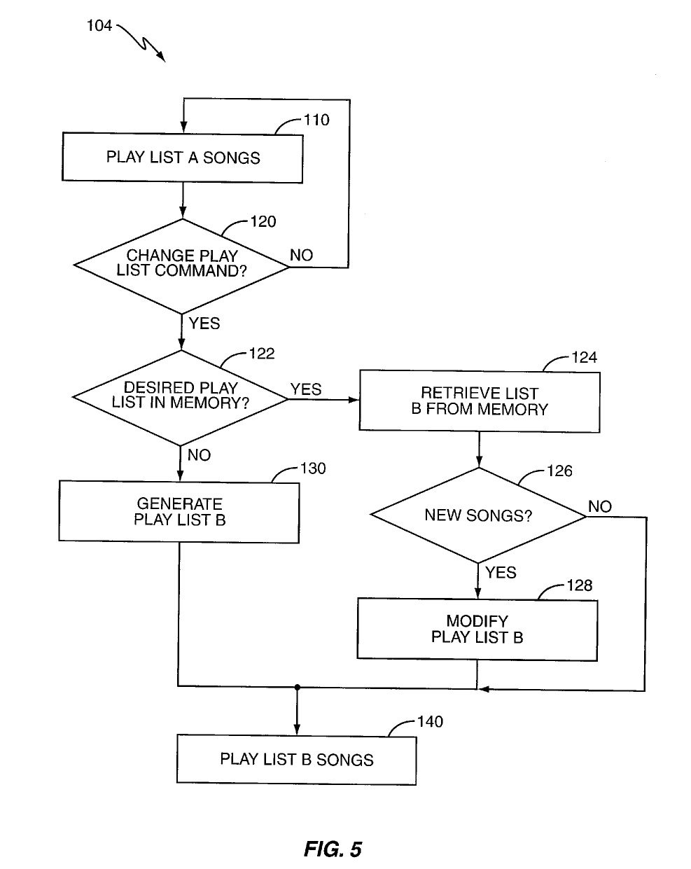

It will further be appreciated that an attribute-specific play list 46 stored in memory may be modified to include new songs added to the music library 42 after the original generation of play list 46. FIG. 5 shows an exemplary process 104 according to this embodiment. Media player 50 plays the songs stored in music library 42 in any desired order, e.g., sequentially, randomly, etc., (block 110). Responsive to receiving the change play list command during playback of a current song (block 120), processor 30 searches memory 40 for a play list 46 of songs having the default attribute of the current song (block 122). For example, processor 30 may search memory 40 for a play list 46 of songs by the artist of the current song. If the play list 46 does not already exist (block 122), processor 30 dynamically generates a new play list 46 based on the attribute of the current song (block 130). However, if the play list 46 already exists in memory 40 (block 122), processor 30 retrieves the play list 46 (block 124). If the music library 42 includes songs having the default attribute of the current song that are not already included in the attribute-specific play list 46 (block 126), processor 30 dynamically adds the missing songs to the play list 46 (block (128). In either case, media player 50 plays the songs from the attribute-specific play list 46 (block 140).

The present invention is not limited to the above-described selective switching between music library 42 and a dynamically or previously generated attribute-specific play list 46 responsive to a change play list command. The mobile device 10 described herein may also selectively switch between a pre-defined personal play list 44 stored in memory 40 and a dynamically generated play list 46 responsive to a change play list command. For example, consider the situation where media player 50 is playing songs from a “Hard Rock” personal play list 44. When mobile device 10 receives a change play list command while playing a Metallica song, processor 30 generates a new play list 46 based on the default attribute associated with the change play list command. If the default attribute is “artist,” processor 30 may generate a new play list 46 comprising all Metallica songs listed in the Hard Rock play list 44. Alternatively, processor 30 may generate a new play list 46 comprising all Metallica songs listed in the music library 42. In either case, media player 50 subsequently plays songs from the new Metallica-specific play list 46.

The above-described invention automatically generates or retrieves a new play list 46 of songs having an attribute of a currently playing song responsive to a change play list command. As such, the present invention provides quick and easy access a group of songs without requiring the user to physically generate a new play list 46. This is particularly useful when the user's attention is engaged elsewhere, such as when the user is driving.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of playing audio files from a play list on a mobile device comprising:
playing audio files from a first play list;
receiving a change play list command from a user during a current audio file;
automatically generating or retrieving a second play list based on an attribute of the current audio file responsive to the change play list command; and
playing audio files from the second play list.

2. The method of claim 1 wherein the first play list comprises one of a music library and a personal play list.

3. The method of claim 2 wherein generating the second play list based on the attribute of the current audio file comprises:
identifying audio files in the first play list having the attribute of the current audio file; and
including the identified audio files in the second play list.

4. The method of claim 2 wherein retrieving the second play list further comprises:
identifying audio files in the first play list having the attribute of the current audio file that are missing from the retrieved second play list; and
automatically modifying the second play list to include the missing audio files.

5. The method of claim 1 wherein the change play list command identifies the attribute of the current audio file.

6. The method of claim 1 wherein receiving the change play list command comprises receiving user input at a control button on the mobile device.

7. The method of claim 1 wherein receiving the change play list command comprises receiving an audio change play list command from the user.

8. The method of claim 7 wherein the audio change play list command identifies the attribute of the current audio file.

9. The method of claim 1 wherein the attribute of the current audio file comprises one of an artist, composer, album, and genre of the current song.

10. The method of claim 9 wherein the genre of the current audio file comprises at least one of a metal, hard rock, jazz, country, folk, swing, seasonal, aggressive, mellow, romantic, classical, hip hop, decade-specific, punk, pop, and alternative genre.

11. The method of claim 1 further comprising:
receiving a second change play list command from the user; and
reverting back to playing audio files from the first play list responsive to the second change play list command.

12. A mobile device comprising:
a media player configured to play audio files from a first play list;
a user input device configured to receive a change play list command from the user while the media player plays a current audio file from the first play list; and
a processor configured to generate or retrieve a second play list of audio files based on an attribute of the current audio file responsive to the change play list command, wherein said media player is further configured to play audio files from the second play list.

13. The mobile device of claim 12 wherein the first play list comprises one of a music library and a personal play list.

14. The mobile device of claim 13 wherein the processor generates the second play list by identifying one or more audio files from the first play list having the attribute of the current audio file, and including the identified audio files in the second play list.

15. The mobile device of claim 13 wherein the processor is further configured to identify audio files in the first play list having the attribute of the current audio file that are missing from the retrieved second play list and to automatically modify the second play list to include the missing audio files.

16. The mobile device of claim 12 wherein the user input device comprises a control button disposed on a housing of the mobile device and configured to generate the change play list command responsive to user activation.

17. The mobile device of claim 12 wherein the user input device comprises an audio input device configured to receive an audio change play list command from the user.

18. The mobile device of claim 12 wherein the change play list command identifies the attribute of the current audio file.

19. The mobile device of claim 12 wherein the attribute of the current audio file comprises one of an artist, album, and genre of the current song.

20. The mobile device of claim 19 wherein the genre of the current audio file comprises at least one of a metal, hard rock, jazz, country, folk, swing, seasonal, aggressive, mellow, romantic, classical, hip hop, decade-specific, punk, pop, and alternative genre.

21. The mobile device of claim 12 wherein the mobile device comprises a wireless communication device.

22. The mobile device of claim 12 wherein the media player comprises an MP3 player.

23. The mobile device of claim 12 wherein the processor is further configured to revert back to playing audio files from the first play list responsive to a second change play list command received at the user input device.
